(19) United States
(12) Patent Application Publication
(10) Pub. No.: US 2008/0129216 A1
(43) Pub. Date: Jun. 5, 2008

(54) Anti-Striation Circuit For A Gas Discharge Lamp Ballast

(75) Inventors: Yuhong Fang, Naperville, IL (US); Michael Y. Zhang, Buffalo Grove, IL (US); Ramakrishnan Venkatraman, Aurora, IL (US); Romel Panlilio, St. Charles, IL (US); Ganesh Arun, Montgomery, IL (US); Rohit Khetarpal, Lisle, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,006

(22) PCT Filed: Nov. 9, 2005
(86) PCT No.: PCT/IB05/53691

§ 371 Date: Nov. 1, 2007

Related U.S. Application Data
(60) Provisional application No. 60/626,749, filed on Nov. 10, 2004.

(51) Int. Cl. H05B 41/298

(52) U.S. Cl. 315/219

(57) ABSTRACT

An anti-striation circuit employs an inverter topology including a pair of electronic switches (Q, M) that are switched between a conducting state and a nonconducting state in an alternating manner to apply an asymmetrical voltage waveform across one or more lamp (LP) to thereby control a flow of an asymmetrical current waveform (i_{acc}) through lamps (LP). To eliminate, if not minimize, visible striations in the lamp(s) (LP), the impedances of an asymmetrical driver as connected to the control inputs (B, G) of the electronic switches (Q, M) may be unequal, and/or the impedances of an asymmetrical driver as connected to the current paths (C-E, D-S) of the electronic switches (Q, M) may be unequal. Additionally, the current gains of the electronic switches (Q, M) may be unequal, and a DC current may flow through the lamp(s) (LP).

The present invention generally relates to electronic ballasts for driving gas discharge lamps (e.g., various types of fluorescent lamps). The present invention specifically relates to a ballast control of a flow of an asymmetrical current waveform through the fluorescent lamp.

As known in the art, a gas discharge lamp converts electrical energy into visible energy and an electronic ballast is utilized to provide the electrical energy in the form of a current waveform flow through the gas discharge lamp. While the designs of gas discharge lamps have become more efficient over the years, a formation of alternating bands of bright and dim areas along an axis of a tube of a gas discharge lamp prevents an efficient operation of the gas discharge lamp. This phenomenon known in the art as a striation is particularly a problem for fluorescent lamps.

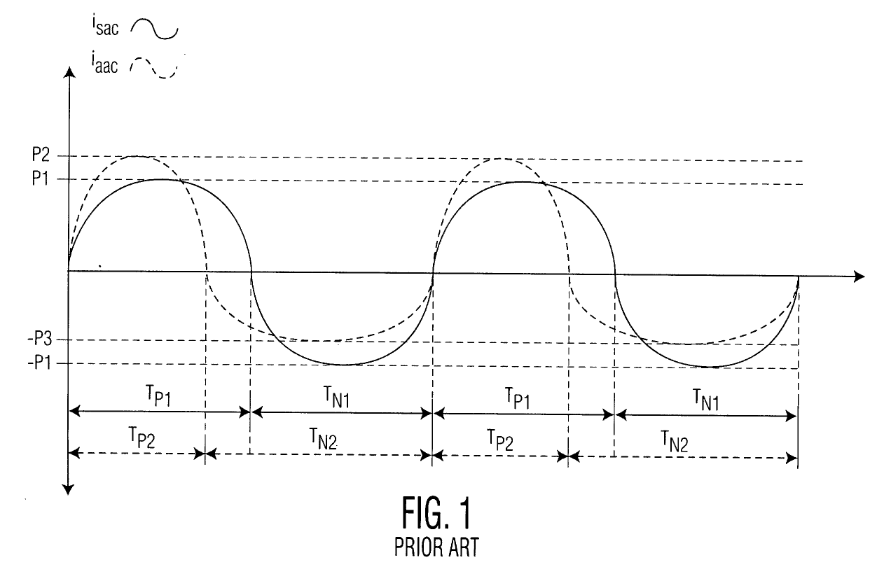

The basis for the formation of the striations is the flow of a symmetrical current waveform through a gas discharge lamp, such as, for example, a symmetrical current waveform i_{sac} having a positive peak amplitude P1 during a positive peak cycle Tₚ₁ and a negative peak amplitude −P1 during a negative peak cycle T_{N1} as illustrated in FIG. 1. One know solution is to control a flow of an asymmetrical current waveform through the gas discharge lamp, such as, for example, an asymmetrical current waveform i_{aac} having a positive peak amplitude P2 during a positive peak cycle T_{P2} and a negative peak amplitude −P3 during a negative peak cycle T_{N2} as illustrated in FIG. 1. Alternatively or concurrently, a DC current (not shown) can be added to an asymmetrical current waveform i_{aac}.

While the lighting industry has provided numerous structural configurations of an anti-striations circuits for minimizing, if not eliminating, visible striations in a gas discharge lamp (e.g., U.S. Pat. Nos. 4,682,082 and 5,369,339), the lighting industry is continually striving to improve upon such circuits. To this end, the present invention provides new and unique structural configurations of anti-striation circuits for minimizing, if not eliminating, visible striations in a gas discharge lamp. Specifically, the present invention is anti-striation circuits employing an inverter topology including a pair of electronic switches (e.g., a push-pull inverter or a half bridge inverter). The anti-striation circuits of the present invention further employ an asymmetrical driver for asymmetrically switching the electronic switches between a conducting state and a non-conducting state in an alternating manner. The present invention provides various structural forms of the asymmetrical driver for applying an asymmetrical voltage waveform across the gas discharge lamp to thereby control a flow of an asymmetrical current waveform through the gas discharge lamp. In the asymmetrical current waveform, the durations and/or the peak amplitudes of the positive half cycles and the negative half cycles are unequal. The result is a minimization, if not elimination, of visible striations in a gas discharge lamp.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

FIG. 1 illustrates an exemplary symmetrical current waveform and an exemplary asymmetrical current waveform for driving gas discharge lamps as known in the art;

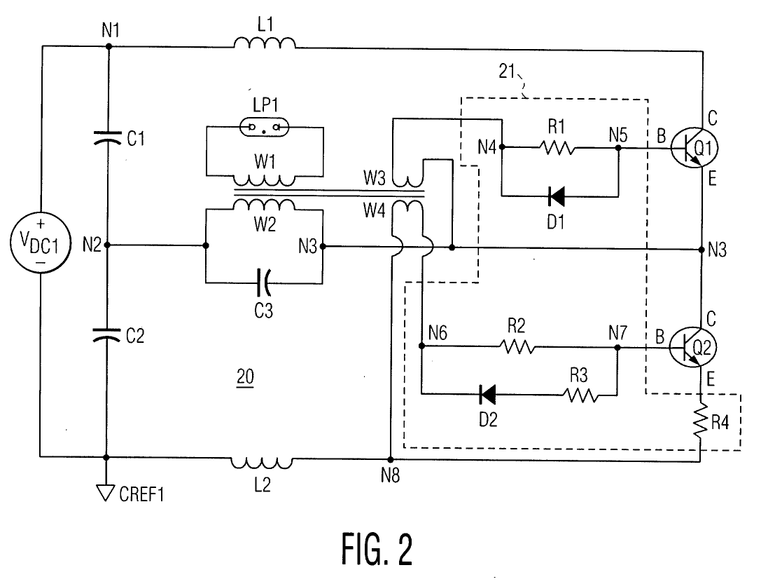

FIG. 2 illustrates a first embodiment of anti-striation circuit for an electronic ballast in accordance with the present invention;

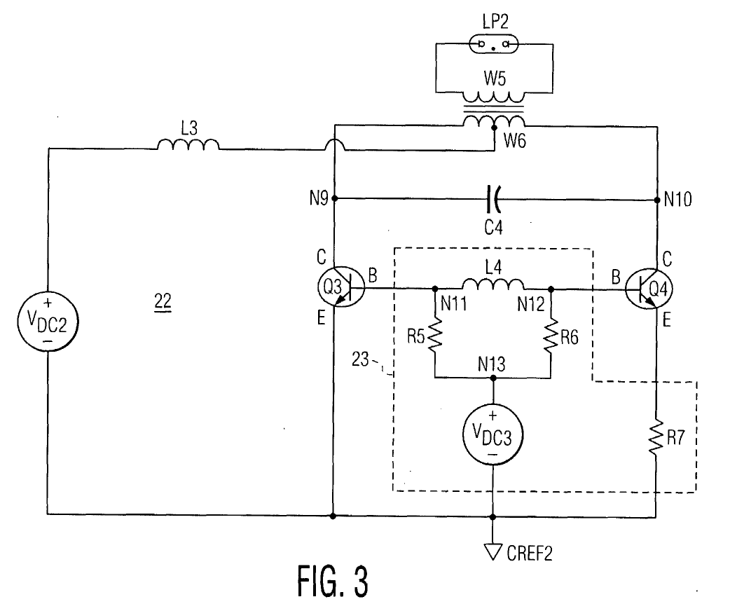

FIG. 3 illustrates a second embodiment of anti-striation circuit for an electronic ballast in accordance with the present invention;

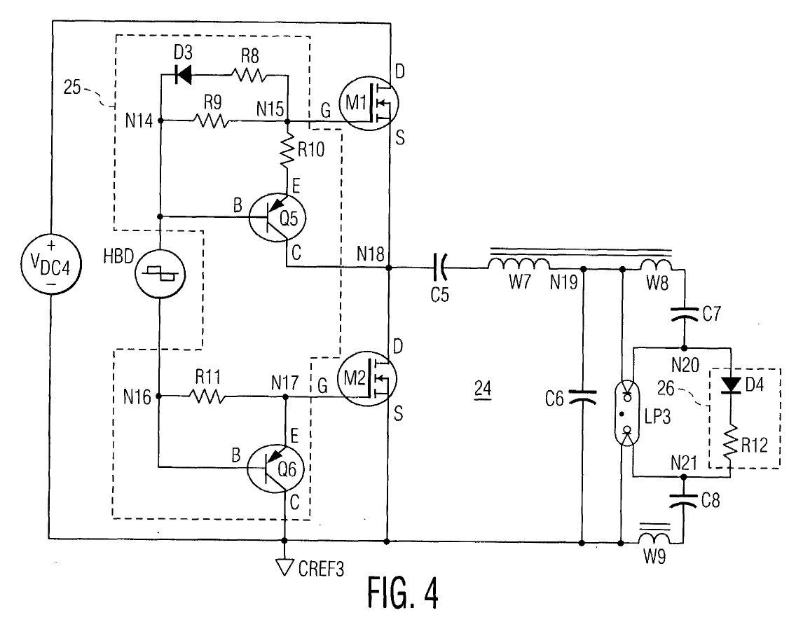

FIG. 4 illustrates a third embodiment of anti-striation circuit for an electronic ballast in accordance with the present invention;

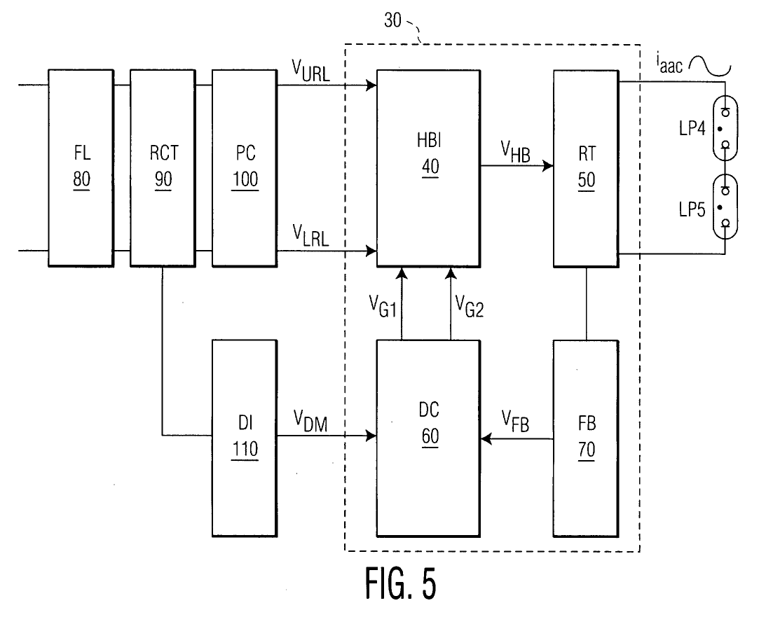

FIG. 5 illustrates one embodiment of an electronic ballast in accordance with the present invention;

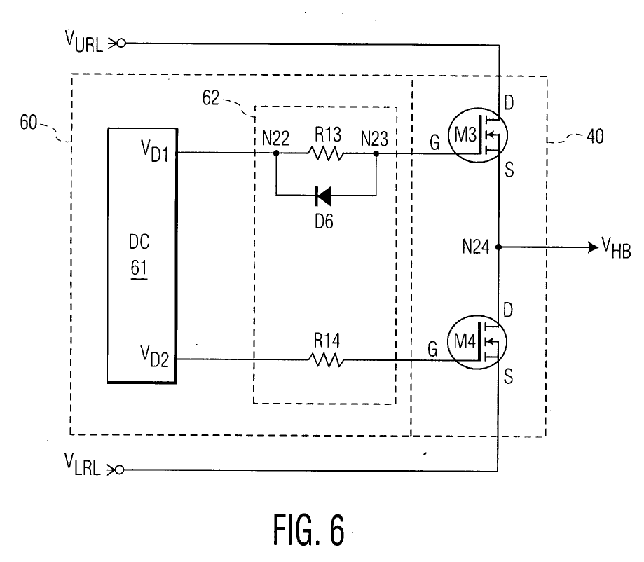

FIG. 6 illustrates a first embodiment in accordance with the present invention of anti-striation circuit for the electronic ballast illustrated in FIG. 5;

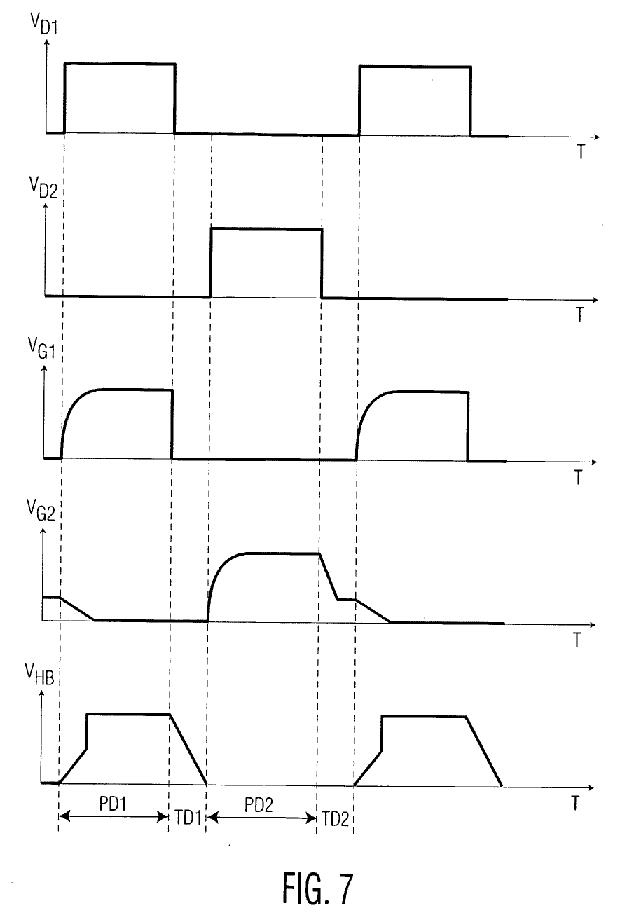

FIG. 7 illustrates an exemplary operation of the anti-striation circuit illustrated in FIG. 6;

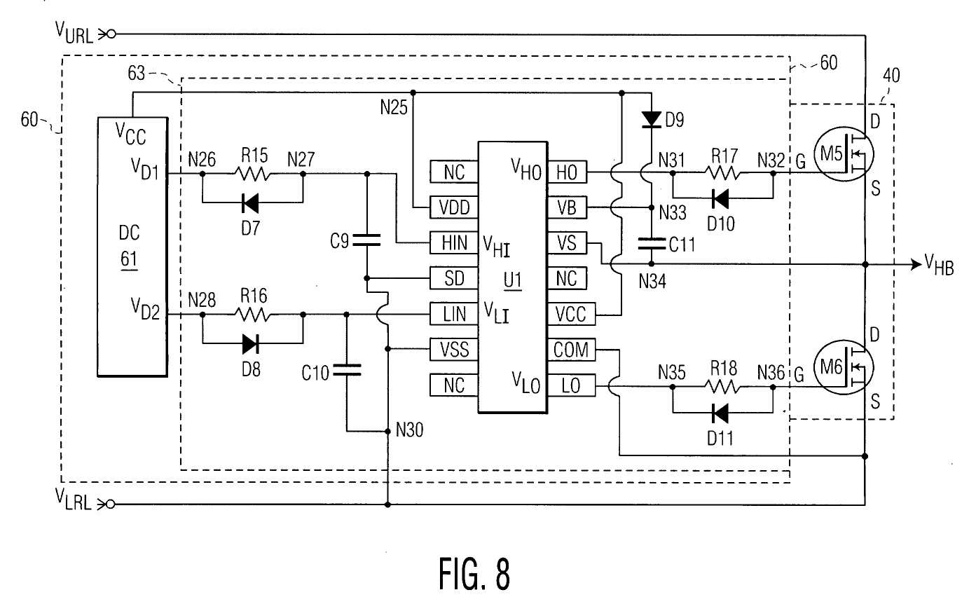

FIG. 8 illustrates a second embodiment in accordance with the present invention of anti-striation circuit for the electronic ballast illustrated in FIG. 5;

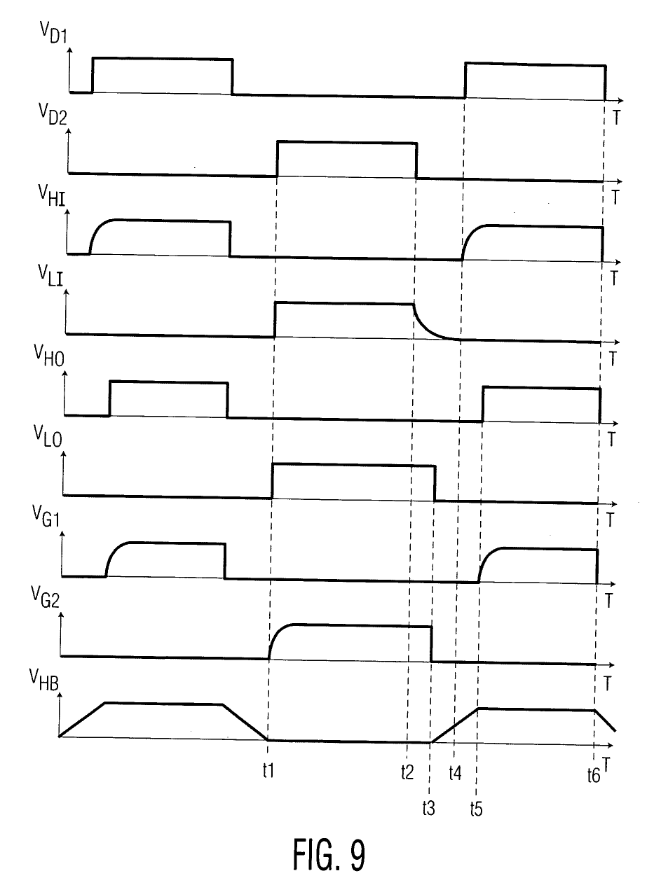

FIG. 9 illustrates an exemplary operation of the anti-striation circuit illustrated in FIG. 8.

An anti-striation circuit 20 illustrated in FIG. 1 minimizes, if no eliminates, striations in a lamp LP1. Generally, circuit 20 employs a transformer and a pair of electronic switches in the form of transistors Q1 and Q2 that are arranged in a push-pull inverter topology with an asymmetrical driver 21 connecting the transformer to transistors Q1 and Q2. The transistors Q1 and Q2 have a current path defined by their collector terminals C and emitter terminals E, and a control input defined by their base terminals B for controlling an open/closed state of the current path.

Specifically, a voltage source V_{DC1} is connected to a node N1 and a common reference CREF1. An inductor L1 is connected to node N1 and collector terminal C of transistor Q1. A capacitor C1 is connected to node N1 and a node N2. A capacitor C2 is connected to node N2 and common reference CREF1. A capacitor C3 is connected to node N2 and a node N3. An inductor L2 is connected to a node N8 and common reference CREF1.

A resistor R1 and a diode D1 of driver 21 are connected in parallel to a node N4 and a node N5. Base terminal B of transistor Q1 is connected to node N5. Emitter terminal E of transistor Q1 and collector terminal C of transistor Q2 are connected to node N3. A resistor R2 of driver 21 is connected to a node N6 and a node N7. A diode D2 and a resistor R3 are connected in series to nodes N6 and N7. Base terminal B of transistor Q2 is connected to node N7. A resistor R4 is connected to emitter terminal E of transistor Q2 and node N8.

The transformer includes four (4) windings W1-W4. Winding W1 is connected to lamp LP1. Winding W2 is connected to nodes N2 and N3. Winding W3 is connected to nodes N3 and N4. Winding W4 is connected to nodes N6 and N8.

Circuit 20 can include additional circuit not shown as would be appreciated by those having ordinary skill in the art.

The basic configuration of driver 21 as shown can be embodied in many forms facilitating an asymmetrical switching of transistors Q1 and Q2 between a conducting state and a non-conducting state in an alternating manner. For each embodiment, either (1) the resistance levels of resistors R1 and R2 are equal or unequal, (2) the knee voltages of diodes D1 and D2 are equal or unequal, (3) resistor R3 is included or omitted, and (4) resistor R4 is included or omitted. Also, the current gains β of transistors Q1 and Q2 may be equal or unequal (e.g., a production spread of 1:2.5).

An anti-striation circuit 22 illustrated in FIG. 3 minimizes, if no eliminates, striations in a lamp LP2. Generally, circuit 22 employs a transformer including a winding W5 and a winding W6 as well as a pair of electronic switches in the form of transistors Q3 and Q4 that are arranged in a push-pull topology with an asymmetrical driver 23 connecting the transformer to transistors Q3 and Q4. The transistors Q3 and Q4 have a current path defined by their collector terminals C and emitter terminals E, and a control input defined by their base terminals B for controlling an open/closed state of the current path.

Specifically, a voltage source V_{DC2} is connected to an inductor L3 and a common reference CREF2. Inductor L3 is connected to winding W6. Winding W5 is connected to lamp LP2. A capacitor C4 is connected to a node N9 and a node N10. Collector terminal C of transistor Q3 is connected to node 9, and collector terminal C of transistor Q4 is connected to node N11. Base terminal B of transistor Q3 is connected to a node N11 and base terminal B of transistor Q4 is connected to a node N12.

An inductor L4 of driver 23 is connected to nodes N11 and N12. A resistor R5 of driver 23 is connected to node N11 and a node 13. A resistor R6 of driver 23 is connected to nodes N12 and N13. A voltage source V_{DC3} is connected to node N13 and common reference CREF2. Emitter terminal E of transistor Q3 is connected to common reference CREF2. A resistor R7 of driver 23 is connected to emitter terminal E of transistor Q4 and common reference CREF2.

Circuit 22 can include additional circuit not shown as would be appreciated by those having ordinary skill in the art.

The basic configuration of driver 23 as shown can be embodied in many forms facilitating an asymmetrical switching of transistors Q3 and Q4 between a conducting state and a non-conducting state in an alternating manner. For each embodiment, either (1) the resistance levels of resistors R5 and R6 are equal or unequal, and (2) resistor R7 is included or omitted. Also, the current gains β of transistors Q3 and Q4 are equal or unequal (e.g., a production spread of 1:2.5).

An anti-striation circuit 24 illustrated in FIG. 4 minimizes, if no eliminates, striations, in a lamp LP3. Generally, circuit 24 employs a half-bridge driver HBD as well as a pair of electronic switches in the form of MOSFETS M1 and M2 that are arranged in a half-bridge topology with an asymmetrical driver 25 connecting half-bridge driver HBD to MOSFETS M1 and M2. MOSFETS M1 and M2 have a current path defined by their drain terminals D and source terminals S, and a control input defined by their gate terminals G for controlling an open/closed state of the current path.

Specifically, a voltage source V_{DC4} is connected to drain terminal D of MOSFET M1 and a common reference CREF3. Half-bridge driver HBD is connected to a node N14 and a node N16. A diode D3 and a resistor R8 of driver 25 are connected in series to node N14 and a node N15. A resistor R9 of driver 25 is connected to nodes N14 and N15. Gate terminal G of MOSFET M1 is connected to node N15. A resistor R10 of driver 25 is connected to emitter terminal E of an emitter terminal E of a transistor Q5 of driver 25. A base terminal of transistor Q5 is connected to node N14 and a collector terminal C of transistor Q5 is connected to a node N18.

A resistor R11 of driver 25 is connected to node N16 and a node N17. Gate terminal G of MOSFET M2 is connected to node N17. A emitter terminal E of a transistor Q6 of driver 25 is connected to node N17. A base terminal of transistor Q6 is connected to node N16 and a collector terminal C of transistor Q6 is connected to common reference CREF3.

Source terminal S of MOSFET M1 and drain terminal D of MOSFET M2 are connected to node N18. Source terminal S of MOSFET M2 is connected to common reference CREF2.

A capacitor C5 and a winding W7 are connected in series to node N18 and a node N19. A capacitor C6 and lamp LP2 are connected to node N19 and common reference CREF3. Lamp LP2 is further connected to a node N20 and a node N21. A winding W8 and a capacitor C7 are connected in series to nodes N19 and N20. A diode D4 and a resistor R12 of a DC offset circuit 26 are connected in series to nodes N20 and N21. A capacitor C8 and a winding W9 are connected in series to node N21 and common reference CREF3.

Circuit 24 can include additional circuitry not shown as would be appreciated by those having ordinary skill in the art.

The basic configuration of driver 25 as shown can be embodied in many forms facilitating an asymmetrical switching of MOSFETS M1 and M3 between a conducting state and a non-conducting state in an alternating manner. For each embodiment, either (1) diode D3 is included or omitted, (2) the resistance levels of resistors R9 and R11 may be equal or unequal, (3) resistor R8 is included or omitted, (4) resistor R10 is included or omitted, and (5) the current gains β of transistors Q5 and Q6 are equal or unequal. Also, resistor R12 of circuit 25 can be embodied as a single resistor as shown or as a chain of resistors.

An electronic ballast 30 as illustrated in FIG. 5 employs a conventional half-bridge inverter (“HBI”) 40, a conventional resonant tank (“RT”) 50, a new and unique asymmetrical half-bridge dimming controller (“DC”) 60, and a conventional feedback circuit (“FB”) 70 for minimizing, if no eliminating, striations in lamps LP4 and LP5. Generally, a conventional EMI/damping filter (“FL”) 80, a conventional rectifier (“RCT”) 90, and a conventional pre-conditioner (“PC”) 100 provides a upper rail voltage V_{URL} and a lower rail voltage V_{LRL} to inverter 40, and a conventional dimmer interface (“DI”) δ 10 provides a dimming voltage V_{DM} to dimming controller 60. In one embodiment, pre-conditioner 100 is based on the ST Microelectronics L6561 PFC controller.

Based on a feedback voltage V_{FB}, asymmetrical half-bridge dimming controller 60 asymmetrically applies a driving voltage V_{G1} and a driving voltage V_{G2} in an alternating manner to inverter 40, which in turns provides an asymmetrical half-bridge voltage V_{HB} to resonant tank 50 to thereby control a flow of an asymmetrical current waveform through lamps LP4 and LP5 (e.g., asymmetrical current waveform i_{aac} (FIG. 1) as shown).

Specifically, FIGS. 6 and 8 illustrate a couple of embodiments of asymmetrical half-bridge dimming controller 60.

The embodiment of asymmetrical half-bridge dimming controller 60 illustrated in FIG. 6 employs a symmetrical half-bridge dimming controller 61 in the form of a Philips UBA2010 chip and an asymmetrical driver 62 for connecting symmetrical half-bridge dimming controller 60 to MOSFETS M3 and M4 of half-bridge inverter 40. MOSFETS M3 and M4 have a current path defined by their drain terminals D and source terminals S, and a control input defined by their gate terminals G for controlling an open/closed state of the current path.

Upper rail voltage V_{URL} is applied to drain terminal D of MOSFET M3, and lower rail voltage V_{LRL} is applied to source terminal S of MOSFET M4. A resistor R1 and a diode D6 of driver 62 are connected in parallel to a node N22 and a node N3. Gate terminal G is connected to node N23. A resistor R14 is connected to driver 62 and gate terminal G of MOSFET M4. Source terminal S of MOSFET M3 and a drain terminal D of MOSFET M4 are connected to node N24.

In operation, as exemplary shown in FIG. 7, dimming voltages V_{D1} and V_{D2} from controller 61 will have equal pulse durations PD1 and PD2 with dead times TD1 and TD2 therebetween to minimizes cross-conduction. A voltage drop of dimming voltage V_{D1} across resistor R13 applies drive voltage V_{G1} to gate terminal G of MOSFET M3 in response to the pulsing of dimming voltage V_{D1} turns on MOSFET M3, which discharges to turn off during dead time TD1. Conversely, a voltage drop of dimming voltage V_{D2} across resistor R14 applies drive voltage V_{G2} to the gate terminal G of MOSFET M3 in response to the pulsing of dimming voltage V_{D2} turns on MOSFET M4, which discharges to turn off during dead time TD2. As shown in FIG. 7, diode D6 causes MOSFET M3 to turn off faster during dead time TD1 than MOSFET M4 turns off during dead time TD2 whereby half-bridge voltage V_{HB} has an asymmetrical waveform.

The embodiment of asymmetrical half-bridge dimming controller 60 illustrated in FIG. 8 employs a symmetrical half-bridge dimming controller 61 and an asymmetrical driver 63 for connecting symmetrical half-bridge dimming controller 60 to MOSFETS M5 and M6 of half-bridge inverter 40. MOSFETS M5 and M6 have a current path defined by their drain terminals D and source terminals S, and a control input defined by their gate terminals G for controlling an open/closed state of the current path.

Upper rail voltage V_{URL} is applied to drain terminal D of MOSFET M5, and lower rail voltage V_{LRL} is applied to a node N30. A resistor R15 and a diode D7 of driver 62 are connected in parallel to a node N26 and a node N27. A resistor R16 and a diode D8 of driver 62 are connected in parallel to a node N28 and a node N29. A capacitor C9 is connected to nodes N27 and a N30, and a capacitor C10 is connected to node N29 and N30.

A half-bridge driver U2 of driver 62 in the form of an International Rectifier IR2113, half-bridge MOSFET driver is employed for driving MOSFETS M5 and M6 based on the dimming voltages V_{D1} and V_{D2}. A pin VDD is connected to a node N25. A high side driving signal input pin HIN is connected to node N27. A pin SD is connected to node N29. A low side driving signal input pin LIN is connected to node N29. A pin VSS is connected to node N30. A high side driving signal output pin HO is connected to a node N31. A pin VB is connected to a node N33. A pin VS is connected to a node N34. A pin VCC is connected to node N25. A pin COM is connected to node N30. A low side driving signal output pin LO is connected to a node N35.

A resistor R17 and a diode D10 of driver 62 are connected in parallel to node N31 and a node N32. A diode D9 of driver 62 is connected to nodes N25 and N33. A capacitor C11 of driver 62 is connected to nodes N33 and N34. A resistor R16 and a diode D8 of driver 62 are connected in parallel to node N35 and a node N36.

Gate terminal G of MOSFET M5 is connected to node N32. Source terminal S of MOSFET M5 and drain terminal D of MOSFET M6 are connected to node N34. Gate terminal G of MOSFET M6 is connected to node N36. Source terminal S of MOSFET M6 is connected to node N30.

In alternative embodiments, a portion or a whole of driver 62 can be integrated, partially or entirely, with dimming controller 61.

In operation, as exemplary shown in FIG. 9, dimming controller 61 symmetrically outputs dimming signals V_{D1} and V_{D2} in an alternating manner. Dimming signal V_{D2} pulses high at a time t1 to charge diode D8, and pulses low at a time t2 to discharge diode D8 to thereby create a time delay (i.e., t3−t2) in the low side output voltage V_{LO} of driver U2 at pin LO whereby a pulse width of dimming signal V_{D2} (i.e., t2−t1) is less than a pulse width of low side output voltage V_{LO} (i.e., t3−t1). Dimming signal V_{D1} pulses high at a time t4 to charge diode D7 with a time delay (i.e., t5−t4), and pulses low at a time t6 to quickly discharge diode D7 whereby a pulse width of dimming signal V_{D1} (i.e., t6−t4) is greater than a pulse width of high side output voltage V_{HO} (i.e., t6−t5) at a pin HO of driver U2. The pulse widths of output voltages V_{HO} and V_{LO} of driver U2 are unequal whereby MOSFETS M5 and M6 have unequal “ON” times to thereby generate half-bridge voltage V_{HB} as an asymmetrical square wave. The capacitance levels of capacitors C9 and C10, the knee voltages of diodes D7 and D8, and the resistance levels of resistors R15 and R16 can be selectively chosen to adjust a degree of asymmetry of half-bridge voltage V_{HB}. Preferably, capacitance levels of capacitors C9 and C10, the knee voltages of diodes D7 and D8, and the resistance levels of resistors R15 and R16 are chosen whereby an absolute difference of a negative duration of half-bridge voltage V_{HB} and a positive duration of half-bridge voltage V_{HB} as divided by the total duration of half-bridge voltage V_{HB} is greater than 20%.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An anti-striation circuit (20), comprising
a push-pull inverter topology including a first electronic switch (Q1), a second electronic switch (Q2) and a transformer; and
an asymmetrical driver (21) for asymmetrically switching the first electronic switch (Q1) and the second electronic switch (Q2) between a conducting state and a non-conducting state in an alternating manner,
wherein the asymmetrical driver (21) includes a parallel connection of a first resistor (R1) and a first diode (D1) connecting a first control input (B) of the first electronic switch (Q1) to the transformer, and
wherein the asymmetrical driver (21) includes a parallel connection of a second resistor (R2) and a second diode (D2) connecting a second control input (B) of the second electronic switch (Q2) to the transformer.

2. The anti-striation circuit (20) of claim 1, wherein a first resistance level of the first resistor (R1) and a second resistance level of the second resistor (R2) are unequal.

3. The anti-striation circuit (20) of claim 1, wherein a first knee voltage of the first diode (D1) and a second knee voltage of the second diode (D2) are unequal.

4. The anti-striation circuit (20) of claim 1, wherein the asymmetrical driver (21) further includes:
a third resistor (R3) connected in series to the second diode (D2), wherein the series connection of the second diode (D2) and the third resistor (R3) is connected in parallel to the second resistor (R2).

5. The anti-striation circuit (20) of claim 1, wherein the asymmetrical driver (21) further includes:
a fourth resistor (R4) connected to a current path of the second electronic switch (Q2).

6. The anti-striation circuit (20) of claim 1, wherein a first current gain of the first electronic switch (Q1) and a second current gain of the second electronic switch (Q2) are unequal.

7. An anti-striation circuit (22), comprising
a push-pull inverter topology including a first electronic switch (Q3), a second electronic switch (Q4) and a transformer, wherein a first current path (CE) of the first electronic switch (Q3) is connected to the transformer and a second current path (CE) of the second electronic switch (Q4) is connected to the transformer, and
an asymmetrical driver (23) for asymmetrically switching the first electronic switch (Q3) and the second electronic switch (Q4) between a conducting state and a non-conducting state in an alternating manner,
wherein the asymmetrical driver (23) includes an inductor connected to a first control input (B) of the first electronic switch (Q3) and a second control input (B) of the second electronic switch (Q4).

8. The anti-striation circuit (22) of claim 7, wherein the asymmetrical driver (23) further includes a first resistor (R5) connected to the control input (B) of the first electronic switch (Q3).

9. The anti-striation circuit (22) of claim 8, wherein the asymmetrical driver (23) further includes a second resistor (R6) connected to the control input (B) of the second electronic switch (Q4).

10. The anti-striation circuit (22) of claim 9, wherein a first resistance level of the first resistor (R5) and a second resistance level of the second resistor (R6) are unequal.

11. The anti-striation circuit (22) of claim 9, wherein the asymmetrical driver (23) further includes a current source (V_{DC3}) connected to the first resistor (R5) and the second resistor (R6).

12. The anti-striation circuit (22) of claim 7, wherein the asymmetrical driver (23) further includes:
a resistor (R7) connected to the current path (CE) of the second electronic switch (Q4).

13. The anti-striation circuit (22) of claim 7, wherein a first current gain of the first electronic switch (Q3) and a second current gain of the second electronic switch (Q4) are unequal.

14. An anti-striation circuit (24), comprising
a half-bridge inverter topology including a first electronic switch (M1), a second electronic switch (M2), and a half-bridge driver (HBD); and
an asymmetrical driver (25) for asymmetrically switching the first electronic switch (M1) and the second electronic switch (M2) between a conducting state and a non-conducting state in an alternating manner,
wherein the asymmetrical driver (25) includes a parallel connection of a first resistor (R9) and a first diode (D3) connecting a first control input (B) of the first electronic switch (M1) to the half-bridge driver (HBD), and
wherein the asymmetrical driver (25) includes a second resistor (R11) connecting a second control input (B) of the second electronic switch (M2) to the half-bridge driver (HBD).

15. The anti-striation circuit (24) of claim 14, wherein a first resistance level of the first resistor (R9) and a second resistance level of the second resistor (R11) are unequal.

16. The anti-striation circuit (24) of claim 14, wherein the asymmetrical driver (25) further includes:
a third resistor (R8) connected in series to the first diode (D3), wherein the series connection of the first diode (D3) and the third resistor (R8) is connected in parallel to the first resistor (R9).

17. The anti-striation circuit (24) of claim 14, wherein the asymmetrical driver (25) further includes:
a third resistor (RIO) connected to the control input (G) of the first electronic switch (M1); and
a third electronic switch (Q5) including a current path (EC) connected to the third resistor (R10) and a control input (B) connected to the half-bridge driver (HBD).

18. The anti-striation circuit (24) of claim 14, wherein the asymmetrical driver (25) further includes:
a third electronic switch (Q6) including a current path (EC) connected to the control input (G) of the second electronic switch (M2) and a control input (B) connected to the half-bridge driver (HBD).

19. An electronic ballast, comprising
a half-bridge inverter (40) including a first electronic switch (M3) a second electronic switch (M4); and
an asymmetrical half-driver dimming controller (60) for asymmetrically switching the first electronic switch (M3) and the second electronic switch (M4) between a conducting state and a non-conducting state in an alternating manner based on a dimming control voltage V_{DIM},
wherein the asymmetrical half-driver dimming controller (60) includes a parallel connection of a first resistor (R13) and a first diode (D6) connected a first control input (B) of the first electronic switch (M3), and
wherein the asymmetrical driver (60) includes a second resistor (R14) connected to a second control input (B) of the second electronic switch (M4).

20. The electronic ballast of claim 19, wherein the asymmetrical driver (60) further includes:
a symmetrical half-bridge driver 60 connected to the parallel connection of the first resistor (R13) and the first diode (D6), and connected to the second resistor (R14).

21. An electronic ballast, comprising
a half-bridge inverter (40) including a first electronic switch (M5) a second electronic switch (M6); and
an asymmetrical half-driver dimming controller (60) for asymmetrically switching the first electronic switch (M5) and the second electronic switch (M6) between a conducting state and a non-conducting state in an alternating manner based on a dimming control voltage V_{DIM},
wherein the asymmetrical half-driver dimming controller (60) includes
a dimming controller (61) for outputting symmetrical dimming voltages in an alternating manner, and
a half-bridge driver (U1) for outputting asymmetrical voltages in an alternating manner as a function of the symmetrical driving voltages.

22. The electronic ballast of claim 21, wherein the asymmetrical half-driver dimming controller (60) further includes;
means for asymmetrically applying each dimming voltage to an input of the half-bridge driver (U1).

23. The electronic ballast of claim 21, wherein the asymmetrical half-driver dimming controller (60) further includes;
means for applying the asymmetrical voltages to a first control input (G) of the first electronic switch (M5) and a second control input (G) of the second electronic switch (M6).
